(19) United States
(12) Patent Application Publication
(10) Pub. No.: US 2010/0270159 A1
(43) Pub. Date: Oct. 28, 2010

(54) Apparatus for Purifying Molecules

(76) Inventors: Alan A. Doucette, Stillwater Lake (CA); John C. Tran, Haliax (CA)

Correspondence Address: Jonathan P. O''Brien, Ph.D.;Honigman Miller Schwartz and Cohn, 350 East Michigan Avenue, Suite 300, KALAMAZOO, MI, 49007, US

(21) Appl. No.: 12/681,880

(22) PCT Filed: Oct. 9, 2008
(86) PCT No.: PCT/CA08/01786

§ 371 Date: Jun. 9, 2010

Related U.S. Application Data
(60) Provisional application No. 60/978,507, filed on Oct. 9, 2007.

(51) Int. Cl. B01D 57/02; C25B 9/00

(52) U.S. Cl. 204/548; 204/600; 204/606; 204/450

(57) ABSTRACT

The invention provides devices for trapping and collecting separated biomolecules following a separation step. The invention also provides methods of using the devices to trap and collect separated biomolecules.

### CLAIM OF PRIORITY

This application claims the benefit of U.S. Provisional application No. 60/978,507 filed Oct. 9, 2007 which is herein incorporated in its entirety by reference.

### FIELD OF THE INVENTION

The invention relates to devices for trapping and collecting separated biomolecules following a separation step. The invention also relates to methods of using the devices.

### BACKGROUND

The analysis of biomolecules, such as proteins, polynucleic acids, lipids and carbohydrates, often requires a means of separation and/or purification. Following a separation and purification process, the sample of interest must therefore be collected and transferred to subsequent analysis platforms, such as a spectrometer. Many methods are available for separation, including chromatographic and electrophoretic separations. The principle underlying the different types of separation is to cause various biomolecules to move through a separating medium at different rates, such that various species in a complex sample become spatially separated over the course of the separation. Once separation is complete, it is therefore a question of how to maintain that spatial resolution, as the samples leave the separation medium and are ready to be transferred to the next step, (e.g., another separation step or analysis step).

Separations are crucial for proteome analysis, with preferred systems offering high resolution, reproducibility and recovery. In proteomics, MS-based peptide sequencing strategies employ well established separation techniques to reduce sample complexity prior to analysis (Washburn, et al., 2001). At the intact protein level, two dimensional electrophoresis continues to be widely employed, yet apart from an unrivalled degree of resolution (Gorg, et al. 2004), two dimensional electrophoresis fails to offer many of the desired features of a separation system (Gygi, et al. 2000).

A recent report by Brunner, et al. describing a “targeted” shotgun approach to proteomics illustrates the importance of intact protein prefractionation to improve analysis (Brunner, et al., 2007). The rising popularity of top-down protein analysis also fuels the need for effective protein separation strategies. Nonetheless, with a few noted exceptions (Nilsson and Davidsson, 2000; Shi, et al., 2004; Wang and Hanash, 2005; Lubman, et al., 2002) optimizing or developing new approaches for proteome separation at the intact level remains an underdeveloped area.

### SUMMARY

The invention relates to apparatuses and methods of trapping and collecting biomolecules after a separation step.

In a first aspect, the invention provides an apparatus comprising a separation device and a collection chamber. The collection chamber comprises an inlet port adapted to receive an end of the separation device, an outlet port comprising a trapping medium and an access port located between the inlet port and the outlet port, wherein the volume of the collection chamber is controlled by adjusting the depth of the separation device in the inlet port relative to the access port. In one embodiment, the separation device comprises an electrophoretic separation device. The separation device of this embodiment can have a separation path length of 10 cm or less and/or can include a separation medium comprising bis-polyacrylamide or agarose. In a specific embodiment, the separation device comprises a polyacrylamide gel that includes a resolving gel of a height of 6.0 cm or less and a diameter of about 0.2-1.0 cm.

In another embodiment, the collection chamber of the apparatus contains one or more removable traps. The traps can include hydrophobic traps, hydrophilic traps, ion exchange traps, molecular weight cutoff traps, affinity traps, or combinations thereof. In embodiments containing more than one trap, the traps can be lined up in series.

In yet another embodiment, the access port in the collection chamber further comprises a valve.

In still another embodiment, the trapping medium in the outlet port of the collection chamber comprises a membrane with a molecular weight cutoff of about 1 kDa to about 10 kDa.

In an additional embodiment, the apparatus comprises two or more collection chambers. The collection chambers can be constructed from a single piece of material. In addition, the spacing between the access ports can be designed to accommodate a standard multichannel pipettor. The access ports can be designed to accommodate a standard pipette tip.

In a further embodiment, the apparatus comprises two or more separation devices and two or more collection chambers. The number of separation devices can be equal to the number of collection chambers, and each collection chamber can be disposed immediately downstream of a separation device. The separation devices and collection chambers can be lined up side by side. The configuration of the multiple separation devices and collection devices can be planar. The multiplex apparatus can also be configured in an arc, a semi-circle, a semi-ellipse, or a tube. The tubular configuration can be a cylinder or an ellipse. The individual separation devices can be lined up side-by-side, or in other configurations, such as a block, depending on the number of units in the multiplex apparatus. The multiplex apparatus can comprise 8 separation devices and 8 collection chambers.

In an additional embodiment, the apparatus further comprises an upper chamber disposed upstream of the separation devices and a lower chamber disposed downstream of the, collection chambers.

In a second aspect, the invention provides a method for purifying multiple molecules or molecular fractions from one or more samples using the apparatus of the invention comprising the following steps: (1) providing one or more samples, (2) separating the molecules using the separation device of the apparatus and (3) sequentially collecting multiple fractions via the access port in the collection chamber.

In one embodiment of the second aspect, the method further comprises a step of applying a sample to the separation device, wherein the loading end of the device is raised to an angle greater than 10 degrees from the horizontal. In another embodiment, the method further comprises a step of allowing the sample to migrate into the separation device, and then lowering the device to an angle of less than 10 degrees from the horizontal.

In still another embodiment of the second aspect, the separating step is conducted in a stop-and-go cycle, with temporary pause of the separating step during each collecting step, followed by reinitiating the separation step after completion of each collecting step.

In yet another embodiment of the second aspect, the separating and collecting steps are performed while the apparatus is in a horizontal position.

In still yet another embodiment, the method further comprises a step of adjusting the volume of the collection chamber by adjusting the depth of the separation device in the inlet port of the collection chamber.

In an additional embodiment, the molecules in the collected fractions have the same or a higher concentration than they had in the sample. In another embodiment, the fractions comprise removable traps. The fractions can also comprise both removable traps and solution in the collection chamber.

In a further embodiment, the samples comprise crude cellular extracts, partially purified extracts, or samples that were previously separated by isoelectric focusing or other method.

In an added embodiment, the apparatus uses an electrophoretic separation device, wherein the molecules are separated using a voltage of about 240 volts. In a further embodiment the separating and collecting steps are performed in about 100 minutes. The separated molecules can be proteins, ranging from about 5 kDa to about 200 kDa, and molecules that have molecular weights of about 5 kDa apart are effectively separated.

In another embodiment, the method further comprises a step of adding buffer to the collection chamber after each collecting step.

### BRIEF DESCRIPTION OF THE DRAWINGS

FIG. 1 is a cross sectional view of one embodiment of the device.

FIG. 2 is an overhead view of one embodiment of the device.

FIG. 3 is a three dimensional view of a collection chamber.

FIG. 4 is a cross sectional side view of a collection chamber.

FIG. 5 is a cross sectional view of a collection chamber.

FIG. 6 shows photographs of one embodiment of the device, showing separation of prestained proteins run on a polyacrylamide gel.

FIG. 7 is an overhead view of one embodiment of a multiplex device.

FIG. 8 is a three dimensional view of a collection chamber of a multiplex device.

FIG. 9 is a cross sectional side view of a collection chamber of a multiplex device.

FIG. 10 is a cross sectional view of a collection chamber of a multiplex device.

FIG. 11 shows silver stained gels of fractions collected from B. subtilis proteins separated on 1 and 3 cm long resolving SDS polyacrylamide gels.

FIG. 12 shows photographs of stained polyacrylamide gels indicating the amount of protein recovered from the collection chamber.

FIG. 13 shows photographs of stained polyacrylamide gels, which indicate the results of three independent separations with the GelFrEE (Gel Fraction Entrapment Electrophoresis) device.

### DETAILED DESCRIPTION

The apparatus and methods of the invention provide a number of advantages over other apparatuses and methods of trapping and collecting separated biomolecules following a separation step. First, the apparatus of the invention directly couples separation of biomolecules to isolation from the separation medium. Second, the apparatus and method provide for concentration of biomolecules concurrently with isolation. Third, the apparatus and method provide for high recovery of biomolecules, even at the low to sub μg level. Fourth, integration of separation of biological molecules with elution and isolation provides significant advantages for the user in saving time, reducing the number of steps required and reducing the amount of space required for the apparatus. Fifth, the apparatus can accommodate a number of different separation devices and separation media. Sixth, the apparatus can be integrated with other separation and analysis devices to obtain a multidimensional platform which is amenable to comprehensive, as well as to targeted analysis of biomolecules.

### I Apparatus

The apparatus of this invention comprises a collection chamber to which a separation device can be directly interfaced.

A. Collection Chamber

The collection chamber of the apparatus of the invention is designed to trap biomolecules in a chamber. The collection chamber is also designed to maintain the spatial resolution of the separated samples after they leave the separation device. To achieve this, the collection chamber directly interfaces with the separation device. The collection chamber includes an inlet port, an outlet port and an access port. The access port allows for direct access to trapped samples for convenient sample collection.

1. Inlet Port

The inlet port of the collection chamber allows for a direct interface with the separation device. The inlet port is designed to accommodate the dimensions of an end of the separation device. Accordingly, the inlet port comprises a circular, elliptical or rectangular hole, or a cylinder, elliptical tube or solid rectangle that allows an end of the separation device to couple directly to the collection chamber. The inlet port can optionally contain a membrane, which can be a molecular weight cut-off membrane. In one embodiment, the membrane is one that retains the separation medium in the separation device, so that the separation medium does not enter the collection chamber. In another embodiment, the membrane can be one has a high molecular weight cut-off, such as 500 kDa. A means for sealing the separating device is available to prevent fluid leakage at the interface of the separation device and to the collection chamber. The sealing means is dependent on the separation medium, and may or may not be needed. For example, for gel electrophoresis, the sealing means can comprise a rubber O-ring and a clamp. The coupling of a separator device to the collection chamber via the inlet port allows for the collection of multiple separated fractions.

The inlet port is also designed so that the volume of the collection chamber can be adjusted simply by controlling the depth of the entry of the separator device into the inlet port.

2. Outlet Port

The outlet port of the collection chamber provides a passage out of the collection chamber and is downstream of the inlet port. The outlet port includes a trapping medium that is selectively permeable to the solvent, as well as certain solutes (e.g., salts, buffer components, and perhaps unwanted biomolecules). The trapping medium can comprise any of a number of trapping media. In one embodiment, the trapping medium is a molecular weight cut-off membrane. This membrane can be any of a number of membranes, including, without limitation, dialysis membranes, nitrocellulose membranes, ultrafiltration membranes or other molecular weight cut-off membranes. The cut-off molecular weight should be lower than the molecular weight of the smallest sample component of interest, e.g., 1-10 kDa. A molecular weight cut-off membrane or other trapping medium, selectively allows passage of some molecules, such as small molecular weight molecules. This selectivity allows for concentration of biomolecules concurrently with their isolation.

3. Access-Port

The access port comprises an opening in the collection chamber between the inlet port and the outlet port. The opening can be of any configuration and dimension, including, without limitation, a circular, elliptical or rectangular opening or an opening comprising a cylinder, elliptical tube or solid rectangle. In one embodiment, the opening comprises a hole above the level of liquid placed in the chamber. In this embodiment, the separation device is run in a horizontal position or at a position between horizontal and vertical. In another embodiment, the access port accommodates standard pipette tips. In yet another embodiment, the access port accommodates the insertion and removal of molecular traps. Accordingly, the access port enables easy access for administering and collecting separated fractions, whether they are trapped in trapping devices or in solution.

The access port can include a valve. A valve is particularly useful if the separation device is run in the vertical position. The valve can be a simple valve, such as a stopcock, leur lock, face seal or side seal valve. The valve can also be a one-way valve, which when open allows flow of liquid in only one direction. Examples of one way valves include, without limitation, a check valve, such as that described by Kim and Bebee (2007), or a one-way valve described by Cheung and Morioka (1990). Other examples of one way valves include those used in valve replacements of medical devices.

4. Interior

The interior of the collection chamber enables retention of fractions, whether in solution or solid phase. The interior is defined by the walls of the collection chamber. The collection chamber can be any configuration, including, without limitation, cylindrical, spherical, square rectangular, and other configurations. In one embodiment, the interior of the collection chamber is cylindrical, with a diameter approximately equal to the outside diameter of a cylindrical separation device.

The interior of the collection chamber can also accommodate trapping device(s), such as hydrophobic traps, hydrophilic traps, molecular weight cutoff traps, ion exchange traps (anionic and/or cationic) affinity traps or combinations thereof. The traps can comprise a medium that traps molecules that have specific physical properties, such as size, charge, hydrophobicity, hydrophilicity, an affinity for a ligand, or combinations thereof. The medium can be contained in an enclosure that allows molecules to enter and leave the trap. For example, a trap can contain an ion exchange resin. In another example, without limitation, the trap could be a guard column insert such as the guard inserts from Phenomenex (Torrance, Calif.). In an embodiment, the collection chamber can accommodate more than one trap so that different types of molecules can be trapped at the same time. The traps can also be lined up sequentially in the collection chamber.

In another embodiment, more than one collection chamber is present in an apparatus that includes one separation device. In this embodiment, the collection chambers can be lined up downstream of the separation device. Collection chambers aligned in this manner can have different molecular weight cut-off membranes between them. In another embodiment, collection chambers can include different molecular traps.

B. Separation Devices

The apparatus of the invention also includes a separation device for separating biomolecules. The separation device includes separation media and a housing to contain the separation media.

The separation media includes any media useful for separating biomolecules. The media includes, without limitation, media that separates biomolecules on the basis of the size or mass of the molecules. These include, without limitation, gel filtration materials, such as sephadex and sepharose and materials for electrophoretic separations based on molecular size, including polyacrylamide and agarose gels. Other separation media include ion exchange materials, including cation and anion exchange resins, affinity materials, including general affinity materials such as phosphocellulose, hydroxyapetite and blue dextran. More specific affinity materials are also included, such as materials carrying a ligand to which certain biomolecules bind. The ligands include, without limitation, antibodies, proteins, peptides, nucleic acid sequences, carbohydrates, and other ligands. The separation media can also include hydrophobic and hydrophilic materials that separate biomolecules on the basis of hydrophobicity.

The separation medium is housed in a device, which generally has an upstream end and a downstream end. The device can take many forms, including a standard cylindrical column. Another form is a solid rectangle, as in, for example, a slab polyacrylamide gel. The size of the housing for the separation medium can vary greatly, depending on the separation medium and the size of the sample. For cylindrical columns, the size can vary from short capillary columns, to very large columns used for large separations, generally for commercial separations, Stationary phase packed columns are also included. Solid rectangle housings can similarly vary from very small to very large housings.

The inlet port of the collection chamber, and in some embodiments, the dimensions of the collection chamber are designed to accommodate the housing of the separation device.

A driving force is necessary for moving biological samples through the separation media. The separator device offers the mobility of solutes into the direction of the collection chamber from a driving force such as, without limitation, electrophoresis, pressure, gravity osmosis, temperature gradients, salt gradients, or combinations thereof.

In cases where the driving force (such as high voltage) results in heat generation, heat transfer or cooling devices can be used to cool the device.

C. Accessories

The device will generally include chambers upstream of the separation device and downstream of the collection chamber. The chambers can contain buffers necessary for moving biological molecules through the chosen separation medium.

The device may also require apparatus for sealing the apparatus from leakage. These can include rubber gaskets and clamps or nuts and bolts, and other apparatus for sealing known to those skilled in the art. The sealing apparatus also serves to seal the molecular weight cut-off membrane at the outlet port of the collection chamber.

D. Materials

The device can be formed of a relatively rigid support material that is non-reactive with the materials placed in contact with it. The material can also be non-conductive. Materials include, without limitation, polymethacrylate, plastics, polypropylene, polycarbonate, PTFE, TEFLON™ or other non-reactive or chemically inert materials. In addition, more than one material can be used to make the device.

E. Polyacrylamide Electrophoresis.

Proteome separations are most beneficial when the elution order of proteins occurs in a predictable fashion. Such predictability permits the isolation of a particular protein, or class of proteins (enrichment of PTM proteins, for example), and can also assist in the identification process (Pal, et al., 2006). The molecular weight of a protein is a constant and clearly offers a defined parameter that is largely unaffected by sample or solvent conditions. Being orthogonal to both charge and hydrophobicity, the molecular weight of a protein presents a highly desirable mode of separation. Unfortunately, very few solution-based systems are established that separate proteins according to size. Membrane filtration and ultrafiltration strategies are inherently labor intensive and offer a low degree of resolution. Size exclusion chromatography has been coupled to other separation platforms (Bushey and Jorgenson, 1990; Opiteck and Jorgenson, 1997; Lecchi, et al., 2003), but has not seen widespread use in proteomics, since it also offers relatively low peak capacity. A size-based protein separation platform with a high degree of resolution, throughput and sample recovery would present a more desirable system.

Sodium dodecyl sulfate polyacrylamide gel electrophoresis (SDS PAGE) is arguably the best method for size-based protein separation. Interestingly, the most serious limitation of SDS PAGE relates to the recovery of protein from the gel, typically following digestion, rather than to the separation process itself (Rabilloud, 2002). The presence of SDS may provide an impending limitation towards MS (mass spectrometric) analysis. However the benefits of SDS in realizing predictable size-based separations, as well as assisting protein solubilization, arguably outweigh its disadvantages. In light of this, it would be most beneficial to take advantage of the high resolving power of SDS PAGE for molecular weight separation, while avoiding the laborious tasks of spot excision, in-gel digestion, and peptide extraction.

As an alternative to solvent extraction, proteins have been electrophoretically isolated from gels following SDS PAGE. The Whole Gel Eluter from Bio-Rad, applies the strategy of electroelution across an entire gel. Davidsson et al. have used this system for fractionation and analysis of proteins from human cerebrospinal fluid (Davidsson, et al. 2001). While the device achieves a broad size-based separation, the restricted number of fractions available with this device limits the flexibility of optimizing resolution. Furthermore, sample loading capacity is limited by the dimensions of the slab gel. Moreover, the Whole Gel eluter would be difficult to multiplex and would not readily integrate into a multidimensional solution-based platform.

As a different strategy to preparative gel electrophorisis, proteins can be eluted from the end of a gel “column” by continuous application of the separating electric field, wherein proteins are trapped by a molecular weight membrane and subsequently collected (Lewis and Clark, 1963; Racusen and Calvanico, 1964; Jovin, et al., 1964; Shain, et al., 1992). This technique is generally referred to as continuous elution tube gel electrophoresis. Although its ability to purify a protein with extremely high resolution has been well established (Masuoka, et al., 1998), the ability to fractionate an entire proteome with such methodology has been problematic (Rose and Opitek, 1994; Meng, et al. 2002; Du, et al., 2004). In general, systems based on this approach are biased towards the lower molecular weight proteins (Meng, et al., 2002; Du, et al., 2004, Zerefos, et al., 2006; Xixi, et al., 2006). Other significant limitations of current systems include long separation times, poor recovery at low sample loadings and an unacceptably large dilution of sample during separation, particularly at high molecular weight. These difficulties need to be overcome before continuous elution electrophoretic techniques can be generally adopted for comprehensive, broad mass proteome separation.

Several techniques are available for separation of proteins and other material according to molecular weight, including ultracentrifugation, membrane filtration, gel filtration chromatography, and capillary (gel) electrophoresis. Of all techniques, however, denatured polyacrylamide gel electrophoresis undoubtedly affords the highest degree of resolution. The conventional format of thin analytical slab gels not only allows for simple but effective heat dissipation, but also provides convenient access to the gel following a separation for sample excision. Historically, PAGE was accomplished in tube gels. The cylindrical shape of an electrophoresis column can be scaled up for higher loading capacities for separating high mass range proteomes, simply by adding a cooling device.

Modification of the technique of preparative gel electrophoresis for use with the apparatus of the invention has a number of advantages. First, it accommodates broad mass range separation of proteins. Second, it allows for rapid fraction of a proteome over molecular weight ranges of approximately 6 kDa to about 200 kDa. Third, it provides for concentration of proteins as samples are collected following separation. Fourth, it allows for high recovery for sample loadings at the low-to sub-microgram level. Fifth, it results in comprehensive reproducible separations of complex protein extracts. And sixth, it can be applied to the isolation and identification of extremely high MW proteome fractions by mass spectrometry.

In one embodiment, the apparatus comprises a short polyacrylamide column of less than 2 cm. Advantages for using a short gel are much faster separations because elution time is proportional to gel length. Shorter columns also mean that the eluted fractions are less diluted over time, In addition, higher voltages can be used because the heat generation is lower. In one aspect, the separation device comprises a short polyacrylamide resolving gel of less than 2 or 3 cm and a stacking gel optionally of 2-3 cm. The resolving gel can have a high percentage of cross linking (about 12 to 15%), for shorter gels that can resolve molecules from less than 10 kDa up to 250 kDa in one 90 minute run using 240 volts. The dimensions of the gel can be scaled up for higher loading capacity.

Compared to SDS polyacrylamide gel electrophoresis, gel-free platforms that separate proteins according to molecular weight are generally of lower resolution and are not applicable across a broad mass range. An embodiment of the present invention therefore optimizes the technique of preparative gel electrophoresis to accommodate rapid, broad mass range proteome separations in the microgram range. Protein fractions are ultimately collected in the solution phase, following electrophoretic migration from the end of the gel column, lending the term post-gel free electrophoresis. This embodiment of the invention, termed Gel Fraction Entrapment Electrophoresis, or GelFrEE, therefore provides an alternative or complementary separation tool for proteome fractionation, which also affords valuable intrinsic information about the sample based on the predictable and reproducible nature of the separation. Because of its compact design, and simple construction, the GelFrEE device is readily compatible to multiplexing.

F. Multiplex Apparatus

The simple design of the apparatus of this invention allows for multiplexing of the device. A multiplex device comprises two or more collection chambers, which are coupled to two or more separation devices. Each collection chamber and each separation device comprise the same components as the device with one collection chamber and one separation device.

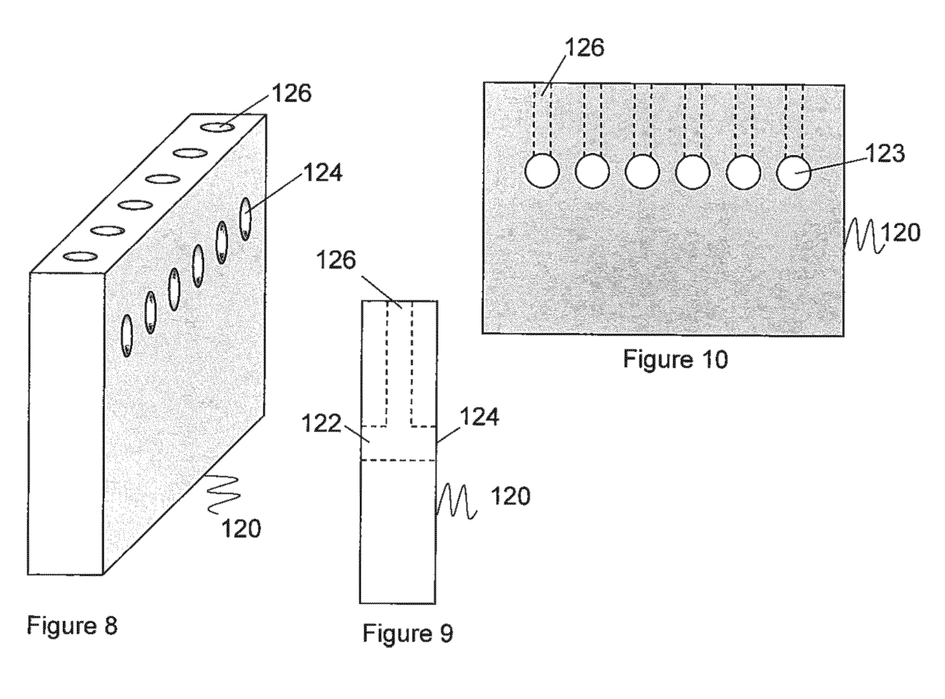

The principle of a multiplex device is to accommodate the separation of a multiple number of samples, each within its own separation device, and individual collection chamber. In one embodiment, the access ports of the collection chambers can be spaced so that fractions or samples can be collected using a standard multichannel pipettor, such that all solutions in the multiple collection chambers can be transferred simultaneously. In another embodiment, the collection chambers are connected and made from the same block of material. An example is shown in FIG. 8.

In another embodiment, there are fewer collection chambers than separation devices. In one embodiment, two separation devices elute into one collection chamber, in another, three or more separation devices elute into one collection chamber.

In yet another embodiment, there is more than one collection chamber for each separation device. In one embodiment, the collection chambers are lined up downstream of the separation device. For example, the apparatus comprises two separation devices, A and B and six collection chambers, 1-6. Collection chamber 1 is immediately downstream of separation device A, collection chamber 2 is immediately downstream of collection chamber 1, and collection chamber 3 is immediately downstream of collection chamber 3. Also collection chamber 4 is immediately downstream of separation device B, collection chamber 5 is immediately downstream of collection chamber 4, and collection chamber 6 is immediately downstream of collection chamber 5. Collection chambers aligned in this manner can have different molecular weight cut-off membranes between them. In another embodiment, they can include different molecular traps.

In another embodiment, there is one separation device containing multiple lanes to accommodate more than one sample. For example, without limitation, the separation device can be a slab polyacrylamide or agarose gel with , e.g., eight lanes. Each lane is connected to a collection chamber. In this embodiment, the collection chambers can be made from one piece of material or each collection chamber can be prepared from one piece of material.

Each separation device connected to a collection chamber can be lined up side by side in different configurations, including, without limitation, a planar configuration, an arc, a semi-circle, a semi-ellipse; or a tubular configuration. The tubular configuration can be cylindrical a tubular ellipse, a rectangular tube or other configurations.

The number of separation devices coupled to collection chambers in a multiplex device can range from two to more than twenty, whatever is practical. In one embodiment, the multiplex device comprises eight separation devices coupled to eight collection chambers,

Each separation device in a multiplex apparatus can have the same configuration and contain the same separation medium as other separation devices in a multiplex apparatus. Alternatively, each separation device can have the same configuration, but contain different separation media from other separation devices in the same multiplex apparatus. Another alternative is for each separation device to have a different configuration from other separation devices in the same apparatus but contain the same separation media as the other separation devices. A fourth alternative is for each separation device to have a different configuration from other separation devices in the same apparatus, and to contain different separation media from other separation devices. The different alternatives can accommodate different samples run on different separation devices of the same multiplex apparatus or different amounts of samples run on different separation devices of the same multiplex apparatus.

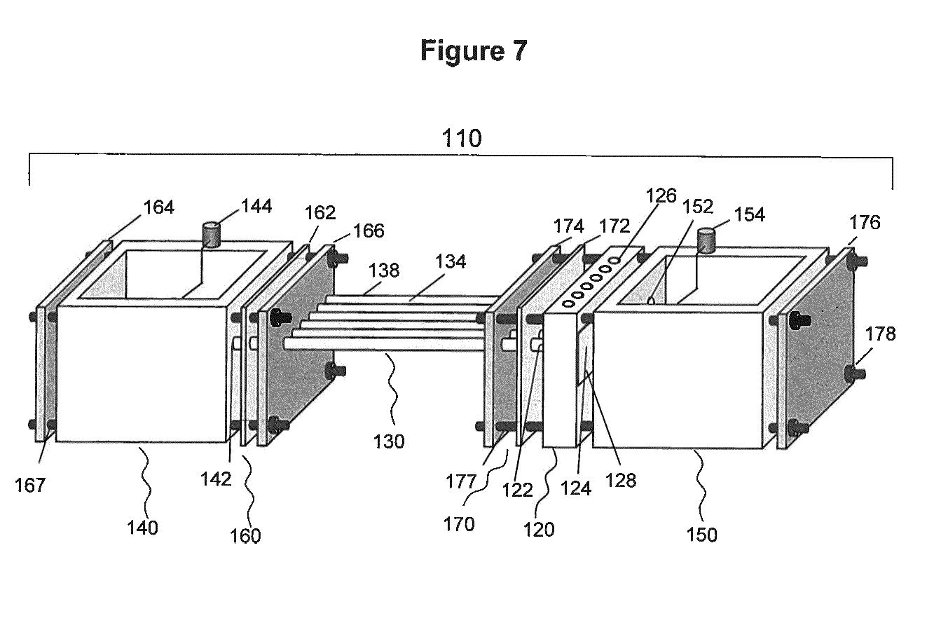

The separation devices can connect to one upstream chamber or each separation device can have its own upstream chamber. For example, a multiplex apparatus can comprise eight separation devices all connected to one upstream chamber, similar to the device illustrated in FIG. 7. Alternatively, each separation device in the multiplex apparatus can have its own upstream chamber, so that for an apparatus with eight separation devices, there would be eight upstream chambers, each upstream of each separation device. Similarly, the collection chambers can connect via their outlet ports to one downstream chamber, similar to the device illustrated in FIG. 7, or each collection chamber can connect to its own downstream chamber.

G. Interface with Other Separation or Analytic Devices

The device can be connected to a parallel device, enabling a high throughput and simultaneous separations and collection. The parallel device can comprise a molecular separation step accomplished before or after separation on the separation device of the apparatus of the invention, or an analytical step, such as mass spectrometry, gas chromatography, HPLC, or any of a number of other analytical steps known to those skilled in the art. The apparatus of this invention can be compact, which makes it easier to connect to a parallel device, although larger apparatuses of the invention can also be connected to other devices.

The multiplex device also has the ability to integrate with other separation devices for a multidimentional separation platform, in which each “fraction” from a first dimension of separation is loaded into one of the separation channels in the multiplexed system. Examples of separation in a first dimension include, without limitation, solution iso-electric focusing, reverse phase HPLC and ion exchange chromatography.

In one embodiment, a multiplex device comprising eight polyacrylamide separating gels can be integrated into a solution isoelectric focusing device. The combination of the two devices can provide a solution-based separation analogous to two-dimensional protein gel electrophoresis. When a short polyacrylamide gel is used, such as one of less than 2 cm, the above combination can provide a solution-based separation analogous to 2D gels that can be completed in under 3 hrs total run time.

### II. Methods

Methods for using the apparatus to separate and collect biomolecules include the following steps: (1) providing a sample or samples, (2) separating the sample using the separation device and (3) collecting fractions of biomolecules from the separation device via the collection chamber.

A. Samples

Samples comprise biomolecules. Any sample that comprises biomolecules can be separated using the apparatus of the invention. For example, the samples can be in the form of crude cellular extracts, partially purified extracts or samples and sub-cellular fractions, such as, without limitation, membrane fractions, nuclear fractions, mitochondrial fractions and cytosolic fractions. The samples can also comprise body fluids from any life form, or extracts of tissues or organs. Partially purified fractions can also be separated using the apparatus. In one embodiment, the samples comprise proteins to be separated, and in another embodiment, the samples comprise nucleic acids. The samples can also comprise synthetic molecules, such as synthetic peptides, proteins, nucleic acids and others.

The samples may be prepared for the separation step. Preparation depends on the separation device and the material in the separation device. For example, if the separation device comprises SDS-polyacrylamide gel electrophoresis, the samples are usually denatured by boiling in a buffer containing SDS (sodium dodecylsulfate), and adding a dye that migrates with the buffer front. If the material in the separation device comprises agarose, for example, the sample is prepared to include the buffer in which the gel is run.

B. Separation

The separation step comprises loading the sample or samples onto the separation device and running the separation device to allow the biomolecules in the sample(s) to separate.

The sample(s) can be loaded onto the separation device in the standard way it is done for the particular separation. For example, for polyacrylamide gel electrophoresis, a liquid sample is applied to the volume above the gel. In one embodiment, using an apparatus in which the collection chamber does not have a valve in its outlet port, the device is raised to an angle greater than 10 degrees from the horizontal to allow the sample to flow by gravity to the top of the separation media. A driving force, such as voltage for a polyacrylamide medium or pressure for ion exchange or gel filtration media, is initiated until the sample has migrated into the medium of the separation device, at which point the raised angle of the device may or may not be lowered.

The separation is next carried out using a driving force to move the biomolecules in the sample(s) through the separation media. If the access port of the collection chamber does not have a valve, the device is kept in a horizontal position or an angled position so that material does not leak out of the collection chamber through the access port. If the access port of the collection chamber has a valve that prevents leakage, the device can be run in a vertical, horizontal, or angled position.

C. Collection

Collection of separated fractions via the collection chamber is performed in a manner depending on the separation device. However, for all devices, the volume of the collection chamber is adjusted by adjusting the depth of the collection device in the inlet port of the collection chamber. This can be done before samples are loaded into the collection chamber and at any time thereafter.

During separation, collection of fractions is performed via the access port in the collection chamber. Fractions can be collected while the driving force is operating, or the driving force can be turned off while each fraction is collected. If the driving force is turned off while each fraction is collected, separation is conducted in a stop and go cycle with temporary pause of the separation during each collection phase, followed by re-initiating the separation after completion of each collection step.

The fractions can be collected after equal time intervals, or the time between collecting each fraction can be varied. The apparatus of the invention allows the user to control the time each fraction is collected, which is an advantage over other devices. In one embodiment, a shorter time interval between collections is set for faster eluting solutes and a longer time interval for longer eluting solutes. This control of collection time leads to less dilution of the longer eluting solutes. Because the collection chamber is held at a constant volume as opposed to the constant flow, the solutes can also be concentrated as opposed to being diluted. Thus, the time between successive collections is gradually increased to accommodate slower moving species as the separation proceeds. For example, when using a medium that separates proteins on the basis of size, the larger the protein, the longer it will take for that particular protein band to elute from the separation medium. To keep the entire amount of that particular protein in the same fraction, it is necessary to accommodate by increasing the collection time. Because of the trap (e.g., a molecular weight cut-off membrane) at the outlet port, molecules in samples remain trapped in the chamber until such time as they are collected or removed.

The collection chamber not only acts as a chamber for collecting samples, but also acts as a pre-concentration chamber in that the absolute amount of solutes in the chamber can increase over time. This is because the collection chamber is held at constant volume as opposed to the constant flow. Accordingly, the adjustable volume of the collection chamber also allows for higher recover when sample loadings are at the sub-microgram level. For example, if loadings are at the sub-microgram level, the volume of the collection chamber can be adjusted to a smaller volume by increasing the depth of the separation device into the inlet port of the collection chamber. The smaller volume of the collection chamber allows for high recovery of low amounts of separated molecules from the sub-microgram sample because the molecules are concentrated in the collection chamber.

Molecular traps described above can be placed in the collection chamber before or during the separation run. This allows the user to collect the separated fractions that remain in the solid phase, i.e., adsorbed onto the trapping device. When using trapping devices in the collection chamber, liquid fractions can also be collected at the same times as the molecular traps. In this embodiment, at each time point, two fractions are collected: one comprising the molecular trap, that includes molecules in the molecular trap, and one in solution, that includes molecules that did were not retained by the molecular trap. In another embodiment, molecular traps may be placed and collected for some but not all of the fractions collected in a separation run. The trapping devices can be sequentially replaced with fresh ones through the access port during the separation run.

In some embodiments, it is necessary to replace buffer in the collection chamber after each sample is collected. For example, if the separation device is polyacrylamide gel electrophoresis, it is necessary to add buffer to the collection chamber after each liquid fraction is collected.

Collection of fractions can be performed manually, or collection can be automated by use of a fraction collector or other devices known to the skilled artisan.

For a multiplex system, the method of use is similar to that of a system with a single separation device and collection chamber.

In one embodiment, the separation medium is a polyacrylamide, agarose or similar type gel. This embodiment, termed multiplex GelFrEE (Gel Fraction Entrapment Electrophoresis) represents a mass-based separation of samples such as proteins, nucleic acids or other biomolecules. The multiplexed device of this invention can accommodate multiple samples in a single run. Voltage applications are identical, as are other conditions such as temperature, and solvent buffer composition. The same sample can be run multiple times for replicate data, or independent samples can also be run simultaneously. In one embodiment, the multiplex device is used to perform multidimensional separations.

For both single sample separations and multiplex separations, fractions collected from a first separation can be subject to additional fractionation using an independent form of separation. For example, for protein analysis, the most common form of multidimensional separation is by 2D gel electrophoresis, which uses a combination of isoelectric focusing (dimension 1) and SDS polyacrylamide gel electrophoresis (dimension 2). While the technique has its strength, there are several known problems of 2D gel electrophoresis that make researchers demand better alternatives.

In one aspect, solution IEF is combined with SDS polyacrylamide gel electrophoresis. In one embodiment, an IEF device that creates 8 fractions of a sample, with volumes on the order of 300 μL per sample is coupled with polyacrylamide gel electrophoresis and collection of samples (GelFrEE) using the apparatus of this invention. A multiplex device of this invention comprising 8 separation devices coupled to 8 collection chambers works well with the 8 samples generated with IEF described above. In this manner, coupling solution IEF to separation and collection using the device of this invention, the separation that 2D gels accomplishes for proteins can be accomplished in solution phase using the multiplex apparatus of this invention.

### III. EMBODIMENTS ACCORDING TO THE DRAWINGS

The specific devices and processes illustrated in the attached drawings, and described in the specification are simply exemplary embodiments of the inventive concepts defined in the appended claims. Hence, specific dimensions and other physical characteristics relating to the embodiments disclosed herein are not to be considered as limiting, unless the claims expressly state otherwise.

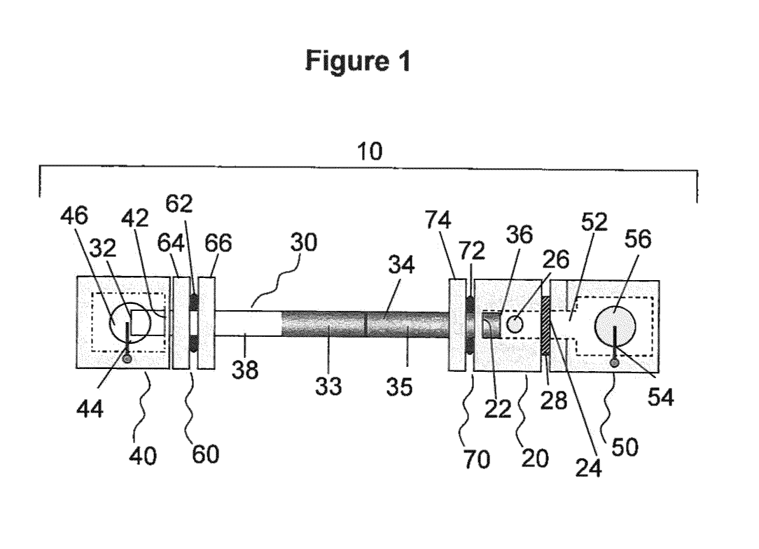

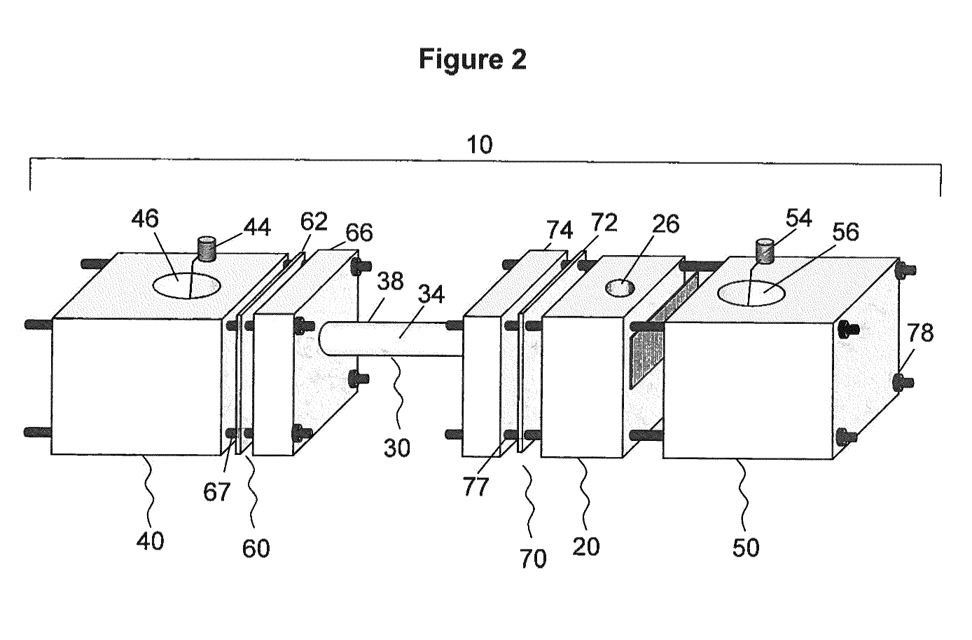

FIG. 1 shows a cross-sectional view of one embodiment of the device of this invention. FIG. 2 shows an overhead view of the embodiment. The reference number 10 generally designates an embodiment of the device shown in FIG. 1. A collection chamber 20 is disposed downstream of a separation device 30. The collection chamber includes an inlet port 22, an outlet port 24 and an access port 26. The collection chamber also includes a molecular weight cut-off membrane 28. The separation device, 30, interfaces with the collection chamber 20 via the inlet port 22. In this embodiment, the inlet port 22 comprises a hole or a cylinder in the upstream end of the collection chamber 20. The outlet port 24 connects the collection chamber with the downstream chamber 50. At the outlet port 24 is the molecular weight cutoff membrane 28. The collection chamber also includes an access port 26, which comprises a hole or valve through which the contents of the collection chamber are accessible.

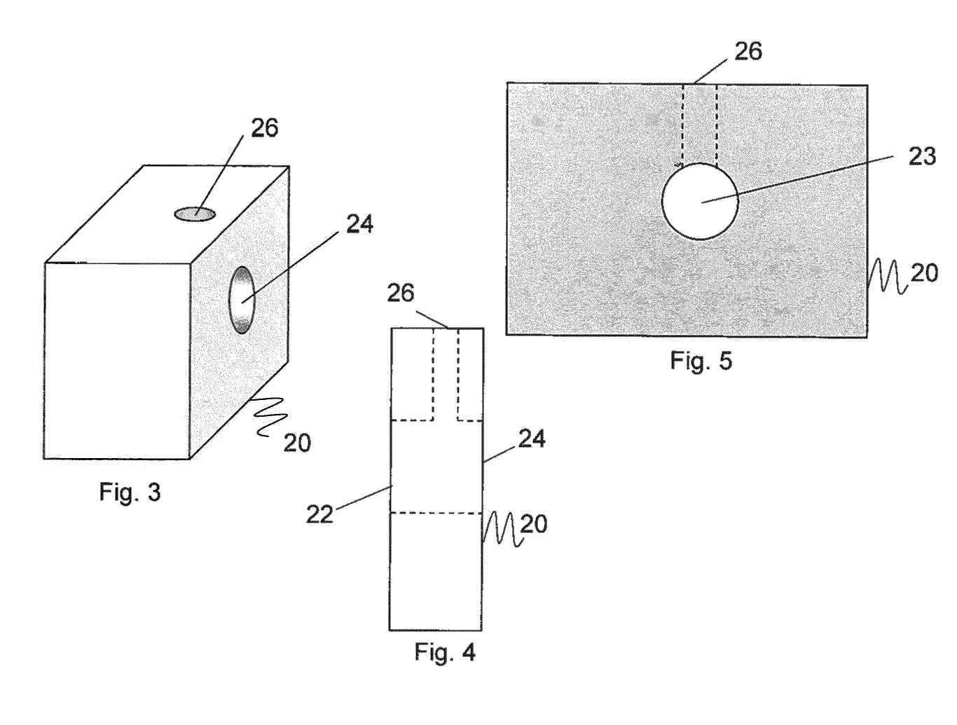

FIGS. 3, 4 and 5 show views of the collection chamber. FIG. 3 shows a three dimensional view of a block containing a collection chamber, showing an outlet port 24 and an access port 26. FIG. 4 is a cross sectional side view of the collection chambers, showing an inlet port 22, an outlet port 24 and an access port 26. FIG. 5 is a cross sectional front view of the collection chamber block, showing an access port 26 and the interior 23 of the collection chamber between the inlet and outlet ports.

The separation device 30 in FIG. 1 comprises a separation medium 34, which includes a stacking medium or gel 33 and a separation gel or medium 35. The separation medium 34 can be polyacrylamide gel, agarose or other separation medium. The separation device 30 comprises a cylindrical tube 38 and the separation medium 34 contained within the tube. The cylindrical tube 38 can be made of glass, siliconized glass or clear plastic, or other clear rigid material.

The device 10 in FIGS. 1 and 2 also includes an upstream chamber 40 and a downstream chamber 50. The upstream end 32 of the cylindrical tube 38 of the separation device 30 connects to the upstream chamber 40 via its outlet port 42. Similarly, the downstream end 36 of the cylindrical tube 38 of the separation device 30 connects to the downstream chamber 50 via its inlet port 52. The upstream 40 and downstream 50 chambers also include electrodes 44, 54 and ports 46, 56. The chambers 40 and 50 typically contain buffer suitable for the separation medium.

The device 10 also includes upstream and downstream sealing apparatuses 60 and 70, respectively. The upstream sealing apparatus 60 comprises a gasket 62, typically made of rubber, and plates 64 and 66 on either side of the gasket 62. The downstream sealing apparatus 70 also comprises a gasket 72, typically made of rubber, and a plate 74 at the upstream end of the gasket 72. The device can be sealed from leakage by clamps or by nuts, e.g., 78 and bolts, e.g., 67, 77, as shown in FIG. 2.

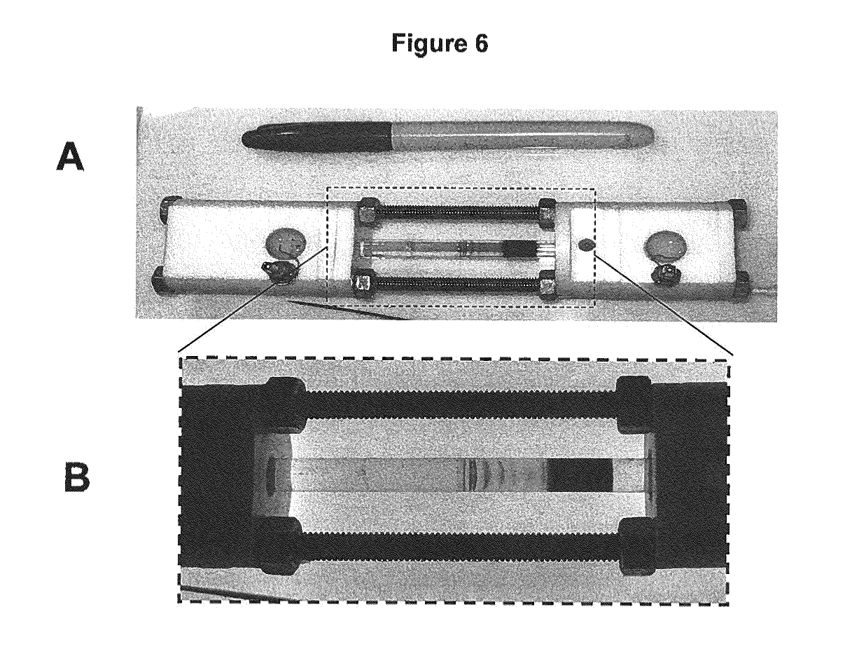

FIG. 6 shows photographs of one embodiment of the device 10.

In operation, the apparatus 10 is assembled and the depth of the separation device 30 into the inlet port 22 or the collection chamber 20 is adjusted to set the volume of the collection chamber. To form a seal around the gel columns, a rubber gasket is also used. A sample is placed into the upstream end 32 of the cylindrical tube 38 of the separation device 30, and allowed to flow to the upstream end of the stacking medium or gel 33. One method of achieving this is to tilt the apparatus 10 to an angle of about 30° from the horizontal, and allow the sample to migrate by gravity to the upstream end of the stacking medium 33. A potential is applied across the upstream electrode 44 and the downstream electrode 54, allowing the sample to migrate into the stacking medium 33. The apparatus can next optionally be lowered to horizontal or to an angle between 30° and horizontal. Collection of samples is accomplished as follows. First, the potential applied across the electrodes 44 and 54 is paused. Second, the entire volume of the collection chamber 20 is transferred to a clean vial using a pipette to access the collection chamber via the access port 26. Third, a fresh portion of buffer is loaded into the collection chamber via the access port 26. Fourth, the potential is reapplied across electrodes 44 and 54 to resume separation. Steps 1-4 are repeated over the course of separation, collecting fractions during each cycle of steps 1-4. The time between each cycle of steps 1-4 can be adjusted during the separation run. An additional step of adjusting the depth of the separation device 30 into the inlet port 22 can be performed between steps 2 and 3.

An embodiment of a multiplex device is shown in FIG. 7, which is an overhead view of the device. Note that FIG. 7 is an expanded view for ease of viewing the components of the multiplex device. In operation, the spaces between, e.g., the collection chambers 120 and the downstream chamber 150 are closed. The reference number 110 generally designates an embodiment of the device shown in FIG. 7. Similar to the device in FIGS. 1 and 2, a block comprising collection chambers 120 is disposed downstream of separation devices 130. Each collection chamber includes an inlet port 122, an outlet port 124 and an access port 126. Each collection chamber also includes a molecular weight cut-off membrane 128. The separation devices 130 interface with the collection chambers 120 via the inlet ports 122. The outlet ports 124 connect the collection chamber with the downstream chamber 150. At the outlet ports 124 is a molecular weight cutoff membrane 128, which in this embodiment of the multiplex device is one membrane that covers all the outlet ports 124. In other embodiments, each outlet port can have a separate molecular weight cutoff membrane. In yet other embodiments, each outlet port of each collection chamber can have a different size molecular weight cutoff membrane. The collection chambers also includes access ports 126, which comprise holes or valves through which the contents of the collection chamber are accessible. In the embodiment shown in FIG. 7, the collection chambers are prepared from one block of material. In other embodiments, the collection chambers can each be prepared separately and lined up with the separation devices 130.

The separation devices 130 in FIG. 7 comprise two or more separation devices. In the embodiment shown, each separation device comprises a cylindrical tube 138, containing a separation medium separation medium 134. The separation medium 134 can be polyacrylamide gel, agarose or other separation medium. The cylindrical tube 138 can be made of glass, siliconized glass or clear plastic, or other clear rigid material. FIG. 7 shows the separation devices identical to each other. In other embodiments, the cylindrical tubes can have different diameters and/or contain different separation media. FIG. 7 also shows six separation devices connected to six collection chambers. The number of separation devices and collection chambers can be as low as two and as high as 200 or whatever is practical. In another embodiment, the number of separation devices and collection chambers is eight, to accommodate a multichannel pipettor.

The device 110 in FIG. 7 also includes an upstream chamber 140 and a downstream chamber 150. The upstream ends of the cylindrical tubes 138 of the separation device 130 connect to the upstream chamber 140 via its outlet port 142. Similarly, the downstream ends of the cylindrical tubes 138 of the separation device 130 connect to the downstream chamber 150 via its inlet port 152. The upstream 140 and downstream 150 chambers also include electrodes 144 and 154. The chambers 140 and 150 typically contain buffer suitable for the separation medium. The embodiment shown in FIG. 7 has one upstream chamber and one downstream chamber into which all separation devices connect. In other embodiments, each separation device is connected to separate upstream and downstream chambers. That is if there are eight separation devices, there are eight upstream and eight downstream chambers.

The device 110 also includes upstream and downstream sealing apparatuses 160 and 170, respectively. The upstream sealing apparatus 160 comprises a gasket 162, typically made of rubber, and plate 164 upstream of the upstream chamber 140, and plate 166 downstream of the gasket 162. The downstream sealing apparatus 170 also comprises a gasket 172, typically made of rubber, and a plate 172 at the upstream end of the gasket 172, and a second plate 176, downstream of the downstream chamber 150. The gaskets 162 and 172 in this embodiment are one sheet of rubber. In other embodiments, the gaskets can comprise rubber rings, with two rubber rings (upstream and downstream) for each separation device. The device is sealed from leakage by nuts 168 and 178 and bolts 167 and 177. The device can also be sealed with clamps.

FIGS. 8, 9 and 10 show views of the collection chambers. FIG. 8 shows a three dimensional view of a block containing collection chambers, showing outlet ports 124 and access ports 126. FIG. 9 is a cross sectional side view of the collection chambers, showing an inlet port 122, an outlet port 124 and an access port 126. FIG. 10 is a cross sectional front view of the collection chamber block, showing access ports 126 and the channels 123 between the inlet and outlet ports.

The multiplex device is operated similarly to the single device. The apparatus 110 is assembled and the depth of the separation devices 130 into the inlet ports 122 of the collection chambers 120 is adjusted to set the volume of the collection chambers. The depth of the each separation device 130 into its respective inlet port 122 can be the same for each separation device and inlet port, thus setting an identical volume for each collection chamber 120. Alternatively, depth of the each separation device 130 into its respective inlet port 122 can be different for each separation device and inlet port, thus setting different volumes for one or more collection chambers 120. The samples are placed into the upstream ends 132 of the cylindrical tubes 138 of the separation device 130, and allowed to flow to the upstream end of the separation medium 134. One method of achieving this is to tilt the apparatus 110 to an angle of about 30° from the horizontal, and allow the sample to migrate by gravity to the upstream end of the stacking medium 134. A potential is applied across the upstream electrode 144 and the downstream electrode 154, allowing the sample to migrate into the separation medium 134. The apparatus can next optionally be lowered to horizontal or to an angle between 30° and horizontal. Collection of samples is accomplished as follows. First, the potential applied across the electrodes 144 and 154 is paused. Second, the entire volumes of the collection chambers 120 are transferred to clean vials or a multiwell plate using a pipette or a multichannel pipette to access the collection chambers via the access ports 126. Third, fresh portions of buffer are loaded into the collection chambers via the access ports 126. Fourth, the potential is reapplied across electrodes 144 and 154 to resume separation. Steps 1-4 are repeated over the course of separation, collecting fractions during each cycle of steps 1-4. The time between each cycle of steps 1-4 can be adjusted during the separation run An additional (optional) step of adjusting the depth of the separation device 30 into the inlet port 22 can be performed between the second and third steps.

During operation, the device is contained inside of a box which acts to protect the user from high voltage application.

### IV. EXAMPLES

The examples, experiments and results described herein are offered to illustrate this invention and are not to be construed in any way as limiting the scope of the present invention.

### Example 1

### Materials

Milli-Q grade water was purified to 18.2 mΩ/m. All reagents for gel electrophoresis were obtained from Bio-Rad (Mississauga, Ontario). 3.5 kDa molecular weight cut-off dialysis membranes were purchased from Fisher Canada (Mississauga, Ontario). All proteins, including trypsin (TPCK treated, cat. T8802), lyophilized Bacilus subtilis, and other chemicals were purchased from Sigma (Oakville, Ontario).

### Example 2

### Sample Preparation

Lyophilized cells of B. subtilis were suspended in pure water and lysed in a French press at 8,000 psi. The lysed bacteria were centrifuged at 13,000'g and the supernatant was collected. The sample was stored at −20° C. until ready to use. Standard proteins were prepared by weight to the approximate concentration. For consistency, 200 μL of sample were loaded in the device, combining 180 μL of the sample with 20 μL of 5×gel loading buffer (0.25 M Tris-HCl pH 6.8, 10% w/v SDS, 50% glycerol, 0.5% w/v bromophenol blue). Samples were heated to 95° C. for 5 minutes for 5 minutes prior to loading onto the column.

### Example 3

### Separation and Collection Device

Apart from the column, the GelFrEE device in these examples is constructed of Teflon, and is shown in FIG. 6. The device comprises four main components: a cathode chamber, a gel column, a collection chamber and an anode electrolyte chamber.

The separation device used in this example is a polyacrylamide gel column, which was cast into a 0.8 cm (outside diameter)×6.0 cm glass tube. Unless otherwise noted, the gel column consisted of a resolving gel that is 1.0 cm in height, cast to 15% T, 2.67% C, along with a 1.5 cm high stacking gel of 4% T, 2.67% C. Gels were prepared using standard procedures for casting analytical slab gels. (Lamelli, 1970) Samples were loaded into the void volume of the glass tube, above the stacking gel.

Following separation, samples are trapped and recovered in the collection chamber. It consists of a round chamber with diameter to match the outer diameter of the glass tube containing the gel column. A 3.5 kDa molecular weight cut-off dialysis membrane was sandwiched between the collection chamber and the anode electrolyte chamber, and sealed by pressure as the chambers were clamped together (see FIG. 6A). An access port was drilled into the top of the chamber, allowing fractions to be removed without disassembling the device. The volume of the collection chamber was adjusted by controlling the depth of the gel column inserted into the chamber.

### Example 4

### Operating Conditions

Operation of the device is described in three distinct stages: (1) sample loading, (2) separation and (3) collection. For sample loading, the electrolyte chambers of the device, as well as the void volume above the gel column were completely filled with running buffer (0.192 M glycine, 0.025 M Tris, 0.1% SDS. (Laeminli, 1970) 100 μL of running buffer were also introduced into the collection chamber. To assist with sample loading, the cathode (loading) end of the device was raised at a 30° angle, such that the sample would flow by gravity onto the head of the stacking gel. Separation occurred with constant application of 240 V across the system. After the sample had entirely migrated into the gel (˜10 min), the device was laid flat for the remainder of the separation. Collection began when the dye front had visibly entered the collection chamber. During collection, the power supply was paused, and, using a pipette, the entire volume of the collection chamber was transferred to a clean vial. A fresh 100 μL portion of running buffer was loaded into the collection chamber, and the power source was switched on to resume separation. This process was repeated over the course of separation, collecting fractions during each stop-and-go cycle.

FIG. 6B shows the separation of a prestained MW protein ladder within the device on a 0.6 cm diameter acrylamide gel at 240 V. The photo was taken approximately 15 min into the separation, as measured upon first application of voltage to the system. Higher voltage application (up to 240 V) provides for faster separations, without deteriorating the resolution of the bands relative to that of lower voltage (120 V) separations (results not shown). Also, a 6 mm diameter tube gel, coupled with a stacking gel that is at least double the length of the sample plug, allows up to 200 μL to be loaded and effectively stacked with the device, providing no noticeable loss in resolution relative to lower volume sample loading. From FIG. 6, one observes a clear separation of proteins, similar to that observed in a conventional analytical slab gel. It is noted from FIG. 6B that the smallest protein (7 kDa) has been completely resolved from the dye front, after migrating through approximately 1 cm of the resolving gel.

### Example 5

### Resolving Gel Column

GelFrEE (Gel Fraction Entrapment Electrophoresis) fractions were analyzed by discontinuous SDS PAGE with 15% T resolving slab gels. For this, 20 μL of GelFrEE-separated fractions were combined with 5 μL of 5×gel loading buffer, and 20 μL of this were loaded onto individual lanes of the gel along with the appropriate standards. Gels were either silver (Shevchenko, et al. 1996) or coomassie stained, and scanned on a flatbed scanner.

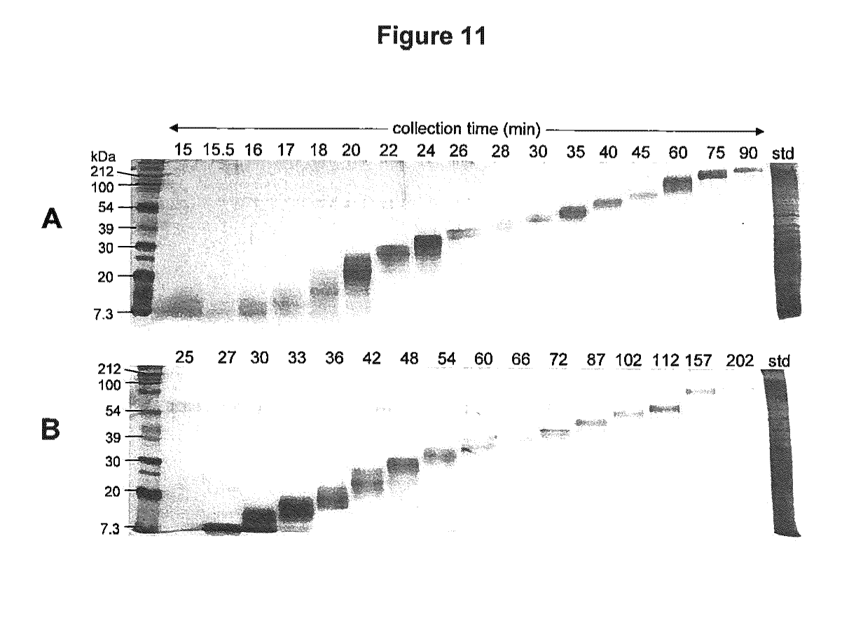

FIG. 11A shows the fractions collected from the separation of a proteome extract of 200 μg B. subtilis using a 1 cm long (resolving) gel column, cast to 15% T. The composition of the resolving gel (i.e., % T) is an important parameter when considering the resolution of a separation over a given mass range. In general, gels cast to lower % T provide optimal resolution for high mass species, whereas a higher % T favors the low mass range. Although it is possible to optimize over a narrow range, in this example, a broad mass range proteome separation was accomplished with the GelFrEE device. To fractionate proteins with a low mass limit extending below 10 kDa, a minimum 15% T gel is required. Below this, proteins elute along with the buffer dye front, and therefore cannot be separated. With a 15% T gel, partial separation can occur even for molecular weight differences as small as 2 kDa.

As seen in FIG. 11A, the last protein fraction, collected at 90 minutes from the initial voltage application, contains protein over the approximate molecular weight range of 150 kDa to 200 kDa (measured from Rᵣ values). Proteins with molecular weights above 100 kDa were easily collected within a 1 hour run. Fast separations are the result of runs conducted at high electric field strengths on short gel columns. FIG. 11 therefore demonstrates the rapid broad mass range separation of essentially the entire proteome under a single set of operating conditions.

The use of an extremely short resolving gel in preparative electrophoresis may appear unconventional. However, due to the nature of protein dispersion, which contributes to band broadening in gel electrophoresis, longer gels may not necessarily afford higher overall resolution, particularly over the entire mass range of the sample. (Yarmola and Charmbach, 1998). Also, assuming a constant electric field, longer gels require proportionally longer separation times. FIG. 11B shows an equivalent separation profile conducted on a 3 cm gel. The separation time with the longer gel increased to over three hours, noting that the upper mass range had yet to reach that of the 1 cm gel separation. Additionally, for reasons of sample recovery from the collection chamber, a run on the 3 cm gel generates approximately three times as many fractions over the course of the separation. As FIG. 11 suggests, the gain in resolution with this longer gel is not significantly different, particularly in the mass ranges of more than 30 kDa. Moreover, the increased work load is compounded by an increase in sample dilution during collection of high mass proteins as they begin to elute across multiple fractions.

A 1 cm gel column provides very impressive resolution over practically the entire proteome mass range, while maintaining maximal throughput by minimizing the total separation time. The separation of FIG. 11 likely represents the largest mass range resolved in a continuous elution gel electrophoretic device, particularly under such a favorable separation time.

### Example 6

### Trapping, A Unique Feature of the Collection Chamber

An apparently linear separation, as displayed by SDS PAGE, (which in fact represents a logarithmic molecular weight separation), is achieved by progressively increasing the separating time interval between the collection of subsequent fractions. These times are inferred from the total indicated separation times indicated in FIG. 11. In doing so, fractionation by GelFrEE easily overcomes the problem of sample dilution experienced with continuous elution electrophoretic devices. In other words, because continuous elution systems employ a constant flowing liquid stream to extract samples from a trapping chamber, larger molecular weight species are inevitably collected in a larger volume, and are thus diluted. This results from the decreased mobility of larger molecular weight species, which increases the elution window of protein bands, being of finite width as a result of dispersive and other processes in the separation. Using the GelFrEE apparatus, despite the increase in elution time, a constant volume is maintained during elution and sample collection. The collection time interval is simply increased to match the increasing elution time window of larger molecular weight proteins. In the experiments reported here, a 200 μL sample loading results in a potential two-fold increase in sample concentration, because protein fractions are collected in 1004 intervals. The device therefore affords collection at much higher mass range by avoiding excessive sample dilution, which is particularly beneficial for low to sub-microgram loadings. Sample recovery from the device is described in detail in the following section.

### Example 7

### Recovery from the Collection Chamber

An important feature of the GelFrEE collection chamber is the trapping efficiency of the 3.5 kDa molecular weight cut-off membrane. Regenerated cellulose acetate has an isoelectric point of 3.5 (Pontie, 1998). At an operating buffer pH 8, the membrane will be negatively charged (Pincet, 1995) and therefore should repel SDS-bound proteins, preventing binding to the membrane. Indeed, when a 2.5 μg/μL solution of BSA was loaded into the collection chamber (by passing the column), within experimental error, we observed quantitative recovery following 30 min trapping at 240 V. The risk of protein loss is expected to increase as protein concentration decreases, and thus a similar experiment was performed using 50 ηg/μL BSA (100 μL total loading). The coomassie-stained gel profiles used to assay the sample suggest high recoveries were observed at trapping intervals ranging from 5 to 15 minutes, indicating that the trapping membrane does not contribute significantly to sample loss with this device. At 30 minutes trapping time, the band intensity in the gel was consistent with some sample loss. Thus, the trapping time interval for a given fraction was maintained below 15 minutes throughout the experiments, in order to prevent sample loss to the membrane at longer trapping within the collection chamber.

### Example 8

### Loading Capacity of the GelFrEE Device

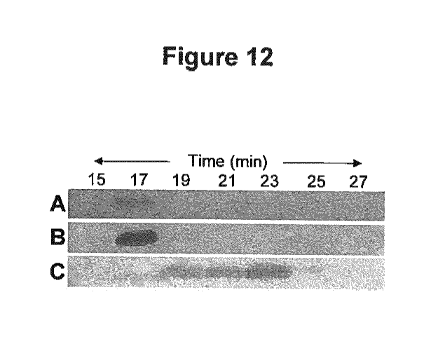

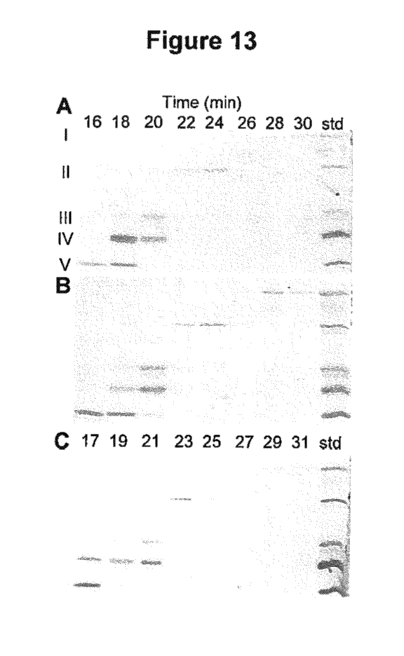

It has been reported that protein recovery from polyacrylamide gels in a continuous elution preparative electrophoresis is dependent on sample loading, falling from 90% to 60% yield as the quantity loaded on the device was reduced from 3 mg to 100 μg per square centimeter of gel (Chrambach and Rodbard, 1971). Sample recovery from the GelFrEE device (0.3 cm² gel column) has been explored over a range of sample loadings, from sub-microgram to milligram quantities. The efficiency of the collection chamber to trap and concentrate samples provides consistently high sample recovery from the device. Using cytochrome C as a single target protein, 0.5 μg (in 200 μL) was loaded and recovered from a GelFrEE experiment, and subsequently visualized in a silver stained analytical slab gel. This is illustrated in FIG. 12A, and represents the analysis of only ⅕^{th} of the total collected fraction from GelFrEE separation. A maximal loading of 10 ηg cytochrome C in this gel approaches the detection limits of silver staining, yet following GelFrEE separation the protein is easily visualized in a single fraction, which represents a separation window of two minutes. At higher sample loadings (up to 200 cytochrome C), high recovery is observed without noticeable loss in resolution (FIG. 12B). However at 1 mg load, resolution started to deteriorate as shown in the coomassie stained gel (FIG. 12C). Owing to effective stacking and sample collection, the 0.6 cm i.d. of the gel column can accommodate sample loadings of up to 2.5 mg for proteome mixtures. FIGS. 13 A, B and C show that resolution remains unchanged for a five protein standard mixture at total protein loads of 1 mg, 0.5 mg and 0.1 mg, respectively. Furthermore, a comparison of band intensity with that of the protein standard lane suggests high recoveries of all proteins in this mass range and at these sample loadings. It is noted that the standard lane of FIG. 13 accounts for the two-fold sample enrichment factor resulting from volume reduction between sample loading and collection. Sample losses are minimized by recovering proteins at high resolution (i.e. in a single fraction), and by avoiding unnecessary dilution once proteins elutes from the gel column. Thus, these results illustrate how GelFrEE sample fractionation and collection provides extremely high protein recoveries over a range of sample loadings.

### Example 9

### Reproducibility

The reproducibility of GelFrEE runs is highly dependent on the consistency of running buffer, as well as the casting the gel columns. The composition of the gel (%T, %C, polymerization process), as well as the column length, must be maintained to provide constant elution times. FIGS. 13 A and B display the gel profiles of a five-protein mixture, separated by GelFrEE using identical conditions and with identical collection times. The images reveal that the bulk of the collected proteins appear in the same collected fractions, or in other words, these proteins elute from the gel column in the same time period. FIG. 13C represents an equivalent separation of the five-protein mixture, except that the fraction collection time was shifted to one minute later than that of the previous images. Proteins are expected to be observed in a lower fraction number. This illustrates the strong influence of small changes in collection time (1 min in a typical 90 minute run) on the elution profile of the sample. Nonetheless, under a controlled set of operating conditions, the GelFrEE device provides highly reproducible separations. High reproducibility ultimately enables the user to predict the molecular weight range of eluting proteins, based directly on the run time under a given set of conditions. This becomes particularly useful for targeted collection of a protein(s) of known molecular weight. This may also provide intrinsic molecular weight information to assist with protein identification.

### REFERENCES

Brunner, E.; Ahrens, C. H.; Mohanty, S.; Baetschmann, H.; Loevenich, S.; Potthast, F.; Deutsch, E. W.; Parise, C.; Lichtenberg, U.; Rinner, O.; Lee, H.; Pedrioli, P. G. A; Malmstrom J.; Koehler, K.; Schrimpf, S.; Krijgsveld, J.; Kregenow, F.; Heck, F.; Heck, A. J. R.; Hafen, E.; Schlapbach, R.; Aebersold, R. Nat. Biotechnol. 2007, 25, 576-583.

Bushey, M. M.; Jorgenson, J. W. Anal. Chem. 1990, 61, 161-167.

Chrambach, A.; Rodbard, D. Science 1971, 172, 440-451.

Chung, Y. K. and Morioka, T, Masui, 1990, 39, 1059-54.

Davidsson, P.; Paulson, L.; Hesse, C.; Blennow, K.; Nilsson, C. L. Proteomics 2001, 1, 444-452.

Davidsson, P.; Westman, A.; Puchades, M.; Nilsson, C. L.; Blennow, K. Anal. Chem. 1999, 71, 642-647.

Du. Y.; Meng, F.; Patrie, S. M.; Miller, Leah, L. M.; Kelleher, N. L. J. Proteome Res. 2004, 2, 801-806.

Gorg, A.; Weiss, W.; Dunn, M. J. Proteomics 2004, 4, 3665-3685.

Gygi, S. P., Corthals, G. L., Zhang, Y., Rochon, Y., Aebersold, R. Proc. Natl. Acad. Sci. U. S. A., 2000, 97, 9390-9395.

Jovin, T.; Chrambach, A.; Naughton, M. A. Anal. Biochem. 1964, 9, 351-369.

Kim, D. and Beebe, D. J., Sensors and Actuators: A Physical, 2007, 136, 426-33.

Laemmli, U. K. Nature 1970, 227, 680.

Lecchi, P.; Gupte, A. R; Perez, R. E; Stockert, L. V.; Abramson, F. P. J. Biochem. Biophys. Methods 2003, 56, 141-152.

Lewis, U. J.; Clark, M. O. Anal. Bichem. 1963, 6, 303-315.

Lubman, D. M.; Kachman, M. T.; Wang, H.; Gong, S.; Yan, F.; Hamler, R. L.; O'Neil, K. A.; Zhu, K.; Buchanan, N. S.; Barder, T. J. J. Chromatograph. B 2002, 782, 183-196.

Masuoka, J.; Glee, P. M.; Hazen, K. C. Electrophoresis 1998, 19, 675-678.

Meng, F.; Cargile, B. J.; Patrie, S. M.; Johnson, J. R.; McLoughlin, S. M.; Kelleher, N. L. Anal. Chem. 2002, 74, 2923-2929.

Nilsson, C. L.; Davidsson, P. Mass Spectrom. Rev. 2000, 19, 390-397.

O'Farrell, P. H. J. Biol. Chem. 1975, 250, 4007-4021.

Opiteck, G. J.; Jorgenson, J. W. Anal. Chem. 1997, 69, 2283-2291.

Pal, M.; Moffa, A.; Sreekumar, A; Ethier, S. vP.; Barder, T. J.; Chinnaiyan, A.; Lubman, D. M., Anal. Chem. 2006, 78, 702-710.

Patrie, S. M., Ferguson, J. T., Robinson, D. E., Whipple, D., Rother, M., Metcalf, W. W., Kelleher, N. L., Mol. Cell. Proteomics, 2006, 5, 14-25.

Pincet, F., Perez, E., Belfort, G., Langmuir, 1995, 11, 1229-1235.

Pontie, M., J. Membr. Sci., 1999, 154, 213-220.

Rabilloud, T., Proteomics, 2002, 2, 3-10.

Racusen, D.; Calvanico, N. Anal. Biochem. 1964, 7, 62-66.

Rose, D. J.; Opiteck, G. J. Anal. Chem. 1994, 66, 2539-2536.

Shain, D. H., Yoo, J. Y., Slaughter, R. G., Hayes, S. E., Ji, T. H., Anal. Biochem., 1992, 200, 47-51.

Shevchenko, A.; Wilm, M.; Vorm, 0.; Mann, M. Anal. Chem. 1996, 68, 850-858.

Shi, Y.; Xiang, R.; Horvath, C.; Wilkins, J. A. J. Chromatogr. A 2004, 1053, 27-36.

Wang, H.; Hanash, S. Mass Spectrom. Rev. 2005, 24, 413-426.

Washburn, M. P.; Wolters, D.; Yates, J. R. Nat. Biotechnol. 2001, 19, 242-247.

Xixi E, Dimitraki P, Vougas K, Kossida S, Lubec G, Fountoulakis M., Electrophoresis, 2006, 27, 1424-31.

Yarmola, E.; Chrambach, A. J. Phys. Chem. B 1998, 102, 4813-4818.

Zerefos, P. G.; Vougas, K.; Dimitraki, P.; Kossida, S.; Petrolekas, A.; Stravodimos, K.; Giannopoulos, A.; Fountoulakis, M.; Vlahou, A. Protoemics 2006, 6, 4346-4355.

### OTHER EMBODIMENTS

It is to be understood that while the invention has been described in conjunction with the detailed description thereof, the foregoing description is intended to illustrate and not limit the scope of the invention, which is defined by the scope of the appended claims. Other aspects, advantages and modifications are within the scope of the following claims.

All references cited herein are incorporated herein in their entirety.

1. An apparatus comprising:
a) a separation device; and
b) a collection chamber comprising:
i) an inlet port adapted to receive an end of the separation device;
ii) an outlet port comprising a trapping medium; and
iii) an access port located between the inlet port and the outlet port, wherein the volume of the collection chamber is controlled by adjusting the depth of the separation device in the inlet port relative to the access port.

2. The apparatus of claim 1, wherein the separation device comprises an electrophoretic separation device.

3. The apparatus of claim 2, wherein the separation device comprises a separation device with a separation path length of 10 cm or less.

4. The apparatus of claim 2, wherein the separation device includes a separation medium comprising bis-polyacrylamide or agarose.

5. The apparatus of claim 1 wherein the separation device comprises a polyacrylamide gel comprising a resolving gel of a height of 6.0 cm or less and a diameter of about 0.2-1.0 cm.

6. The apparatus of claim 1, wherein the collection chamber contains a removable trap.

7. The apparatus of claim 6, wherein the collection chamber includes two or more removable traps.

8. The apparatus of claim 6, wherein the removable trap comprises a hydrophobic trap, a hydrophilic trap, an ion exchange trap, a molecular weight cutoff trap, an affinity trap, or a combination thereof.

9. The apparatus of claim 7, wherein the traps are arranged end to end.

10. The apparatus of claim 1, wherein the access port in the collection chamber further comprises a valve.

11. The apparatus of claim 1, wherein the trapping medium comprises a membrane with a molecular weight cutoff of about 1 kDa to about 10 kDa.

12. The apparatus of claim 1, wherein the apparatus is constructed essentially of a chemically inert, non-conductive material.

13. The apparatus of claim 1, wherein the apparatus comprises two or more collection chambers.

14. The apparatus of claim 13, wherein the collection chambers are constructed from a single piece of material.

15. The apparatus of claim 13, wherein the spacing between the access ports is designed to accommodate a standard multichannel pipettor.

16. The apparatus of claim 13, wherein the access ports are designed to accommodate a standard pipette tip.

17. The apparatus of claim 1344, wherein the collection chambers are disposed downstream of each other, in line with the separation device.

18. The apparatus of claim 13 further comprising two or more separation devices.

19. The apparatus of claim 18, wherein the number of separation devices is equal to the number of collection chambers, and each collection chamber is disposed immediately downstream of a separation device.

20. The apparatus of claim 18, wherein the separation devices and collection chambers are lined up side by side.

21. The apparatus of claim 20, wherein the apparatus comprising separation devices and collection chambers lined up side by side is in a planar configuration.

22. The apparatus of claim 20, wherein the apparatus comprising separation devices and collection chambers lined up side by side is configured in an arc, semi-circle, or semi-ellipse.

23. The apparatus of claim 20, wherein the apparatus the apparatus comprising separation devices and collection chambers lined up side by side is configured in a tubular configuration

24. The apparatus of claim 23, wherein the tubular configuration is a cylinder or an ellipse.

25. The apparatus of claim 18, wherein the apparatus further comprises an upper chamber disposed upstream of the separation devices and a lower chamber disposed downstream of the collection chambers.

26. The apparatus of claim 18, wherein the apparatus comprises 8 separation devices and 8 collection chambers.

27. A method for purifying multiple molecules or molecular fractions from one or more samples using the apparatus defined in claim 1, the method comprising:
a) providing one or more samples;
b) separating the molecules using the separation device; and
c) sequentially collecting multiple fractions via the access port in the collection chamber.

28. The method of claim 27, further comprising a step of applying a sample to the separation device, wherein the end of the device containing the applied sample is raised to an angle greater than 10 degrees from the horizontal.

29. The method of claim 28, further comprising the step of allowing the sample to migrate into the separation device, and then lowering the device to an angle of less than 10 degrees from the horizontal.

30. The method of claim 27, wherein the separating step is conducted in a stop-and-go cycle, with temporary pause of the separating step during each collecting step, followed by reinitiating the separation step after completion of each collecting step.

31. The method of claim 27, wherein the separating and collecting steps are performed while the apparatus is in a horizontal position.

32. The method of claim 27, further comprising the step of adjusting the volume of the collection chamber by adjusting the depth of the separation device in the inlet port of the collection chamber.

33. The method of claim 27, wherein the molecules in the collected fractions have the same or a higher concentration than they had in the sample.

34. The method of claim 27, wherein the fractions comprise removable traps.

35. The method of claim 34, wherein the fractions comprise both removable traps and solution in the collection chamber.

36. The method of claim 27, wherein the samples comprise crude cellular extracts, partially purified extracts, or a sample that was previously separated by isoelectric focusing or other method of separating molecules.

37. The method of claim 27, wherein the molecules are separated using a voltage of about 240 volts.

38. The method of claim 37, wherein the separating and collecting steps are performed in about 100 minutes.

39. The method of claim 38, wherein the separated molecules are proteins, ranging from about 5 kDa to about 200 kDa, and wherein molecules that have molecular weights of about 5 kDa apart are effectively separated.

40. The method of claim 27, further comprising the step of adding buffer to the collection chamber after each collecting step.
